(19) United States
(12) Patent Application Publication
(10) Pub. No.: US 2003/0065655 A1
(43) Pub. Date: Apr. 3, 2003

(54) Method and apparatus for detecting query-driven topical events using textual phrases on foils as indication of topic

(75) Inventor: Tanveer Fathima Syeda-Mahmood, Cupertino, CA (US)

Correspondence Address: Samuel A. Kassatly, 6819 Trinidad Drive, San Jose, CA, 95120, US

(73) Assignee: International Business Machines Corporation, Armonk, NY

(21) Appl. No.: 10/219,023

(22) Filed: Aug. 13, 2002

Related U.S. Application Data
(60) Provisional application No. 60/326,286, filed on Sep. 28, 2001.

(51) Int. Cl. G06F 7/00

(52) U.S. Cl. 707/3

(57) ABSTRACT

A method and apparatus for detecting query-driven audio events in digital recordings focus on the detection of specific types of events, namely topical events, that occur in classroom or lecture environments, where it may be understood that topical events are defined as points in a recording where a topic is discussed. The method focuses on the problem of time-localized event detection, and identifies topical events. It enables browsing of long recordings by their topical content, making it valuable for semantic browsing of recordings. Specifically, the method of detecting topical audio events uses the text content of slides as indications of topic, and takes a query-driven approach where it is tacitly assumed that the desired topical event can be suitably abstracted in the topical phrases used on foils. The method identifies a duration in a recording during which a desired topic of discussion was heard, wherein the desired topic of discussion is identified and summarized by a group of text phrases on a slide. The method also admits text phrases arising from other data forms such as text script or textbook, and hardcopy foils, though a preferred embodiment is for the case of topical phrases listed on electronic slides.

### CROSS-REFERENCE TO RELATED APPLICATIONS

This application claims the priority of the U.S. provisional patent application, Serial No. 60/326,286, filed on Sep. 28, 2001, titled “Method and Apparatus for Detecting Query-Driven Topical Events Using Textual Phrases on Foils as Indication of Topic”, assigned to the same assignee as the present application, and incorporated herein by reference in its entirety.

This application is related to co-pending U.S. patent application Ser. No. 09/593,206, titled “Method for Combining Multi-Modal Queries for Search of Multimedia Data Using Time Overlap or Co-Occurrence and Relevance Scores,” filed on Jun. 14, 2000, which is assigned to the same assignee as the present application, and which is incorporated herein by reference.

### FIELD OF THE INVENTION

This invention relates generally to the field of automated information retrieval. More specifically, it relates to a method and implementation of an automated detection and retrieval of topical events from recordings of events that include digital audio signals, as exemplified by lectures for distributed/distance-learning environments.

### BACKGROUND OF THE INVENTION

The detection of specific events is essential to high-level semantic querying of audio-video databases. One such application is the domain of distributed or distance learning where querying the content for events containing a topic of discussion is a desirable component of the learning system. Indeed, based on a survey of the distance learning community, it has been found that one of the primary needs of students in this learning environment is the ability to accurately locate topics of interest on relatively long, recordings of course lectures. Therefore, it would be desirable to provide a method of detecting and localizing topical events, that is, the points in a recording when specific topics are discussed.

Often in such lectures or seminars, slides or foils are used to convey topics of discussion. When such lectures are video taped, at least one of the cameras used captures the displayed slide, so that the visual appearance of a slide in video can be a good indication of the beginning of a discussion relating to a topic. However, the visual presence alone may not be sufficient, since it is possible that a speaker flashes a slide without talking about it, or can continue to discuss the topic even after a slide is removed. In such cases, and also in cases where the visual appearance of foils was not captured, the detection of topics using the audio track becomes essential.

In general, topical detection under such conditions is a very challenging problem, requiring the detection and integration of evidence for an event available in multiple information modalities, such as audio, video and language. While a number of studies have been conducted on event perception in various fields the automatic detection of events has remained a challenging problem for many reasons.

For example, difficulties are associated with the accurate detection of relevant segments in which a topic is presented by semantic analysis of the audio track alone, which method seemingly presents the most straightforward and accessible means of achieving this goal. However, due to errors in speech recognition, not all the words in a phrase may find correct matches (i.e., relevant matches may not be found or there may be spurious “matches”). Secondly, if the word order of occurrence is not taken into account, the matches to individual words in the phrase may be sprinkled throughout the video and accurate segment identification would be difficult. Third, while preserving the order of occurrence of words in phrases can bring up potentially relevant matches to individual topical audio segments, unless their contiguous co-occurrence is exploited, a duration over which the topic was heard cannot be accurately assessed.

Problems remain even if the information base is expanded. In the best existing techniques for visual or audio analysis, event detection using individual cues, robustness problems still exist due to detection errors. Events are often multi-modal, requiring the gathering of evidence from information available in multiple media sources such as video and audio. The localization inaccuracies with individual cue-based detection often lead to conflicting indications for an event at different points of time making their multi-modal fusion difficult.

Previous work on the automatic detection of events has primarily focused on actions including event classification, and object recognition for a review for capturing visual events. The automatic detection of auditory events, on the other hand, has been mainly limited to discriminating between music, silence and speech.

The notion of combining audio-visual cues has also been explored, though not for event detection. In general, the methods of combining cues have considered models such as linear combination including Gaussian mixtures, winner-take-all variants, rule-based combinations, and simple statistical combinations. None of these has been shown to be entirely satisfactory. Thus, despite the progress made in image and video content retrieval, making high-level semantic queries, such as looking for specific events, has still remained a far-reaching goal.

### SUMMARY OF THE INVENTION

This invention addresses these and other problems by providing a method and apparatus for detecting query-driven audio events in digital recordings. The present invention achieves this goal by focusing on the detection of specific types of events, namely topical events that occur in classroom or lecture environments, where it may be understood that topical events are defined as points in a recording where a topic is discussed.

The present method is further distinguished by its focus on the problem of time-localized event detection rather than simple topic detection, the latter being an example of bottom-up detection. Identifying topical events enables browsing of long recordings by their topical content, making it valuable for semantic browsing of recordings.

Specifically, this invention presents a novel method of detecting topical audio events using the text content of slides as indications of topic. This method takes a query-driven approach where it is tacitly assumed that the desired topical event can be suitably abstracted in the topical phrases used on foils. The method identifies a duration in a recording during which a desired topic of discussion was heard, wherein the desired topic of discussion is identified and summarized by a group of text phrases on a slide. The method also admits text phrases arising from other data forms such as text script or textbook, and hardcopy foils, though a preferred embodiment is for the case of topical phrases listed on electronic slides.

Accordingly, the present invention achieves these and other advantages by presenting the following features:

First, the present invention incorporates a novel method of topical event detection based on the phrasal content of foils. In particular, by relying on the phrases listed on a foil as a useful indication of the topic, the invention searches the audio track of the digital recordings for places where the phrases were spoken. The search uses a combination of word and phonetic recognition of speech, and exploits the order of occurrence of words in a phrase to return points in recordings where one or more sub-phrases used in the foil were heard. The individual phrase matches are then combined into a topical match for the audio event using a probabilistic combination model that exploits their contiguity of occurrence.

While individual matches to phrases can be widely distributed, there exist points in time where a number of these matches either co-occur, or occur within a short span of time. If such matches can be grouped based on an inter-phrasal match distance, then it is likely that at least one such group spans the topical audio event conveyed by the slide. This represents an important observation behind combining phrasal matches to detect topical audio events. Additionally, the present invention employs a novel method of multi-modal fusion for overall topical event detection that uses a probabilistic model to exploit the time co-occurrence of individual modal events, where multiple textual phrases refer to individual modes.

Second, the top-down slide text phrases-guided topic detection indicates that a match to a phrase identifies a subtopical event and that the collection of such subtopical event matches to phrases collectively define a topical event. In addition, the word order of the query phrase is preserved throughout, to maximize accuracy.

Third, the present invention introduces a unique way of segmenting topical event groups using statistics of inter-phrasal match distribution.

Fourth, the topical audio event is determined by combining the individual probabilities of relevance of phrasal matches.

Fifth, whereas existing methods of topic detection in audio are based on a bottom-up analysis of the transcribed text (e.g. a simple measure of the frequency of a word or phrase), the present invention exploits the co-occurrences of words/phrases as well as the order of occurrence to indicate topical relevance. It uses text on a slide as a useful indication of topic and focuses on finding a time-localized region of the video in which the topic of discussion event occurred.

In particular, the invention relies on textual phrases summarizing the topic of discussion, as captured on foils, to identify topical audio events. In addition the invention uses a probabilistic model of event likelihood to combine the results of individual event detection, exploiting their time co-occurrence.

Topical audio events are automatically identified by observing patterns of co-occurrence of individual topical phrasal matches in audio and segmenting them into contiguously occurring duration as topical event duration. The match to individual topical phrases is generated using a combined phonetic and transcribed text-based audio retrieval method which ranks durations in audio based on their probabilities of correctness to the query text phrase in a way that preserves the same order in utterance of words as in their occurrence in the text phrase. The grouping of durations returned as matches for individual text phrases then takes into account both their probabilities of relevance and their contiguity of location, to identify the most probable durations for the overall topic listed on a slide.

To this end, the present invention describes an algorithm that is used for the detection of topical event in the following manner: Electronic slides appearing in the video are processed to isolate textual phrases. The text content on a slide is extracted using conventional OLE (object linking and embedding) code. For slides in image form (as opposed to the electronic form for a preferred embodiment), the text can be extracted using a suitable optical character recognition (OCR) engine. Text separated by sentence separators (e.g., periods, semicolons, and commas), or by carriage returns is grouped into a phrase.

The audio track of the video is processed as follows: The audio track is extracted from the video and analyzed using a speech recognition engine to generate a word transcript. A sentence structure is imposed using a language model through tokenization, that is extraction of the basic grammar elements that are also referred to as terminals of the grammar, and part-of-speech tagging, followed by stop-word removal to prevent excessive false positives during retrieval. To account for errors in word boundary detection, word recognition and out-of-vocabulary words, a phone-based representation of the audio is extracted to build a time-based phonetic index.

The products of these operations are word and phoneme indices that are then represented as tuples. Embedded in these tuples are the points in time where the words and phonemes occur, as well as their respective recognition probabilities. Thus, given a query phrase the matches to individual words are retrieved based on a combined word and phone index, along with a time stamp and a probability of relevance of the match.

The best match to the overall query phrase that preserves the order of occurrence of the words is then found by enumerating all common contiguous subsequences. The probabilities of relevance of each subsequence is then computed simply as the average of the relevance scores for each of the element matches. All those with probabilities of relevance above a chosen threshold are retained as matches to a query phrase.

The patterns of separation between individual phrasal matches are analyzed to derive threshold for inter-phrasal match distance. All match durations separated by inter-phrasal match distance are then grouped using a fast connected component algorithm. During grouping, multiple occurrences of a match to a phrase are allowed within a group to handle cases when a phrase emphasizing a point of discussion was uttered frequently. The resulting time intervals form the basic localization units of the topical event using the audio cue.

The time interval groups produced in the foregoing steps are then ranked using probability of relevance criteria. The highest ranked interval represents the best match to the topical event based on audio information.

The result of these processes is an accurate identification and location of query-driven topics relying on audio cues and employing statistical methods to achieve multi-modal fusion.

### BRIEF DESCRIPTION OF THE DRAWINGS

The above and further objects, features and advantages of invention will become clearer from the more detailed description read in conjunction with the following figures in which:

FIG. 1 is a block diagram illustrating an overall system architecture of an environment that uses a topical event detector of the present invention;

FIG. 2 is a more detailed block diagram of a topical index creation module within a media processing facility shown in FIG. 1.

FIG. 3 is a block diagram of a topical search engine that forms part of a Web server shown in FIG. 1;

FIG. 4 is a block diagram of a topical event detector module; and

FIG. 5 is a sample slide query for use with the topical event detector of FIG. 1;

FIG. 6 illustrates the result of individual phrase match distribution of the topical phrases of FIG. 5 in an audio track of the associated course video; and

FIG. 7 illustrates the result of phrasal match grouping that groups individual matches to phrases in FIG. 6.

### DETAILED DESCRIPTION OF PREFERRED EMBODIMENTS

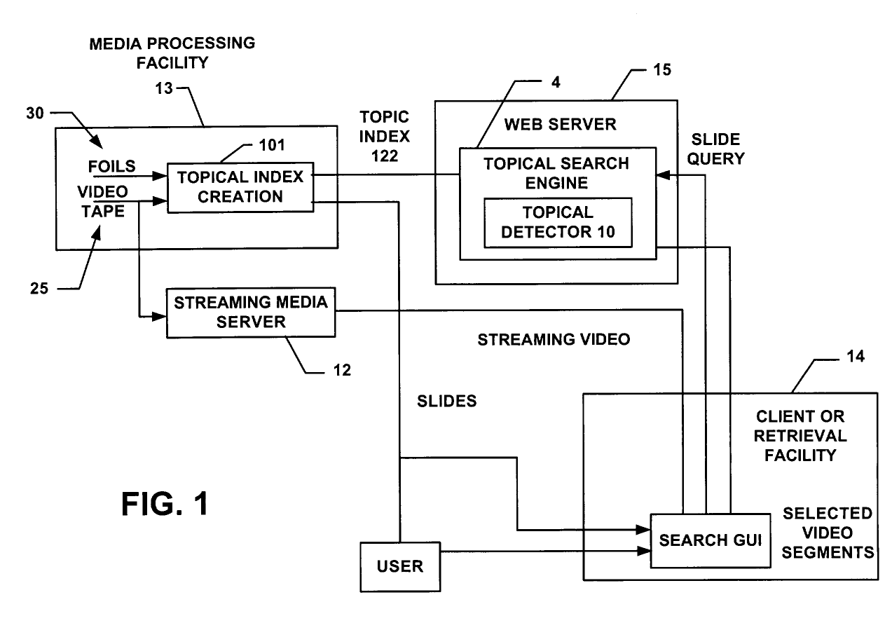

FIG. 1 provides a high level architecture of a representative environment for a query-driven topical detector 10 of the present invention. In a preferred embodiment, the detector 10 resides within a topical search engine 4 lying within a distance learning facility. The distance learning facility can, for example, be comprised of three components: a course preparation module with a media processing facility 13, a web-server 15 and a streaming media server 12. Information for the topical detector 10 is produced within a topical index creation module 101 in the media processing facility 13. The media processing facility 13, the search facility 15, and the replay facility 14 may be co-located or widely separated.

In an exemplary scenario for the use of the topical detector 10, a lecture, demonstration, or other presentation (collectively referred to herein as “presentation” or “recording”), is captured on, for example, a video tape 25 within a recording studio. The information captured on tape 25 can include images of electronic slides or foils 30, other video or visual images, in addition to verbal information. The result is a tape 25 with both audio information and video information. The analog tape 25 is digitized before being fed to the media processing facility 13. The digital form is assumed to be in a suitable format that can be played by a media player at a replay facility 14, possibly using the capabilities of the streaming media server 12.

A user, such as a student, may choose to replay the event by watching the event at a later time at the replay facility 14 of the distance learning center. As is often the case, the user may be interested in only a discrete number of topics from the tape 25 with the further restriction of not desiring to view the entire tape to look for the instances of that topic.

The user provides the topical search engine 4 with a foil query 45, with the topical search engine 4 providing the required search functionality by using a topic index 122 created by the topic index creation module 101, to find the most probable location(s) of a desired topic in the video tape 25.

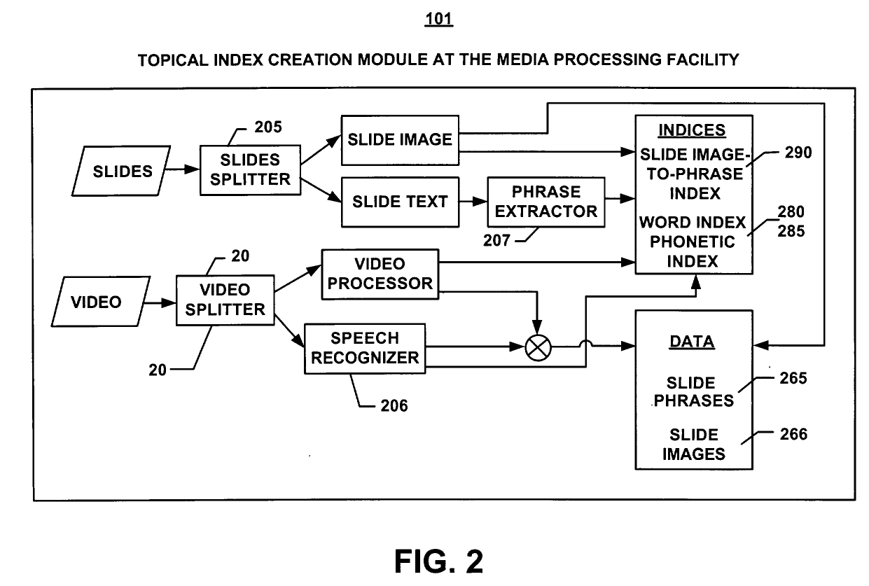

With reference to FIG. 2, the functional elements of the topic index creation module 101 include a preprocessing stage (or slide splitter module 205 that separates the text on foils from their image appearance. The separation of text and image content of foils can be done in a variety of ways including using OLE code that interfaces to a presentation application, such as Microsoft's Powerpoint®.

The foil text is analyzed by a phrase extractor 207 to generate the slide phrases 265. The phrase extractor 207 employs English punctuation rules and indentation rules for foils (e.g., the use of bullet symbols to separate text). In this processing, the carriage returns (e.g., CR's) within a single sentence are ignored, in order to group the largest possible set of words into a phrase. Thus, text separated by sentence separators (e.g., commas, semicolons, periods, or carriage returns) is grouped into a phrase.

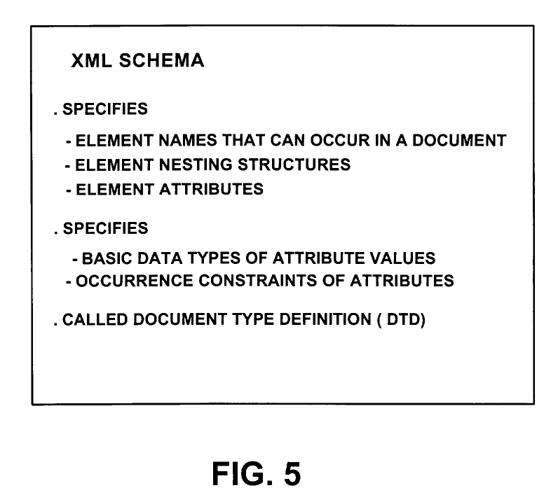

As an illustration, in the foil shown in FIG. 5, the phrases extracted by this process are: (1) XML Schema, (2) specifies, (3) element names that can occur in a document, (4) element nesting structures, (5) element attributes, (6) specifies, (7) basic data types of attribute values, (8) occurrence constraints of attributes, and (9) called document type definition.

The slide phrases 265 and the slide images 266 (FIG. 2) represent the output data produced during the topic index creation stage, which are then stored in the Web server 15 for later use while processing queries by users.

Simultaneously to this process, a video splitter 208 (FIG. 2) separates the audio information from the video information. Audio information is separated into three basic categories: music, silence, and voice, using an audio segmentation algorithm.

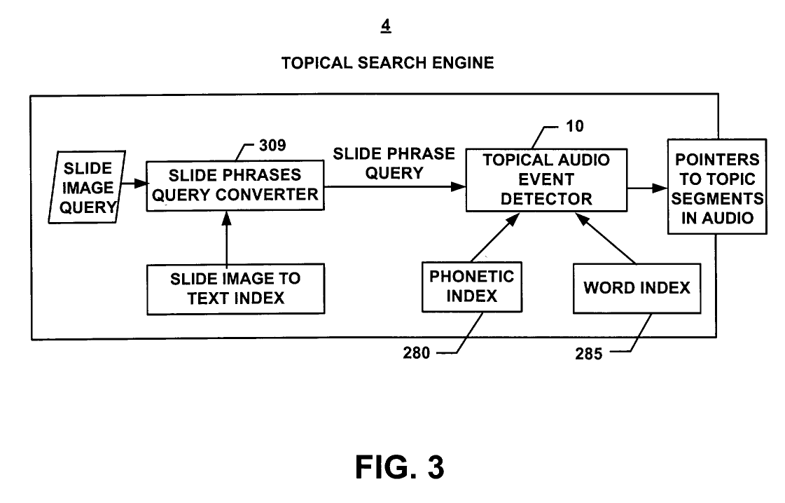

Voice information is processed by a speech recognition module (or recognizer) 206 to extract the audio index. In particular, and with reference to FIG. 3, the audio track is processed to extract word and phoneme indices 280 and to construct word/phoneme databases. A word index 285 is obtained using a standard speech recognition engine 206, such as IBM's® ViaVoice™, with word recognition vocabularies of 65,000 words or more.

From this script, the word index is created. Each element of the word index 285 is represented as a tuple (w, t_{w}, p_{w}), where w is the word string, tw is the time when it occurred, and pw is the confidence level of recognition. A sentence structure is imposed on the word index 285 using a language model through tokenization (i.e., extracting words), and part-of-speech tagging. The words thus obtained are filtered for stop words to prevent excessive false positives during retrieval.

To account for errors in word boundary detection, word recognition, and out-of-vocabulary words, a phone-based representation of the audio may be required. From this script, a time-based phonetic index 280 is derived. Each element of the phoneme index 280 is also represented as a tuple: (s, tₛ, pₛ), where s is the phoneme string, tₛ is the time when it occurred, and pₛ is its recognition probability.

The products of these operations are word indices 280 and phoneme indices 285 that are then represented as tuples. Embedded in these tuples are the points in time where the words and phonemes occur, as well as their respective recognition probabilities. Thus, given a query phrase the matches to individual words can be retrieved based on a combined word and phone index, along with a time stamp and a probability to relevance of the match.

Simultaneous to audio processing, a video processing module acts on the video information to process the video information into shots and to extract keyframes within the shots. The keyframes are matched to the images of foils to align the video information with the slide image content. The slide recognition in video stage could be implemented using a technique known as region hashing. The video processing module is optional in this embodiment.

The indices produced during the topic index creation stage includes a word index 185 and a phonetic index 280 for audio information, and a slide-to-phrase index 290. Both the data and index creation stages can be implemented as an offline operation for efficiency of operation. Both the data and topic indexes can be stored on the Web server 15 of FIG. 1, for later use during retrieval.

Referring now to FIG. 3, it shows the functional modules of the topical search engine 4. A user's query of a topical foil image is used to retrieve the topical phrases inside the foil using the slide image-to-phrase index 290 in a slide phrase query converter 309. The topical event detector 10 uses the word and phonetic index 285, 280 and exploits the order of occurrence of words in a phrase to return points in the video where one or more sub-phrases used on the slide were heard. The individual phrase matches are then combined into a topical match for the audio event using a probabilistic model to exploit the time co-occurrence of the individual phrase matches.

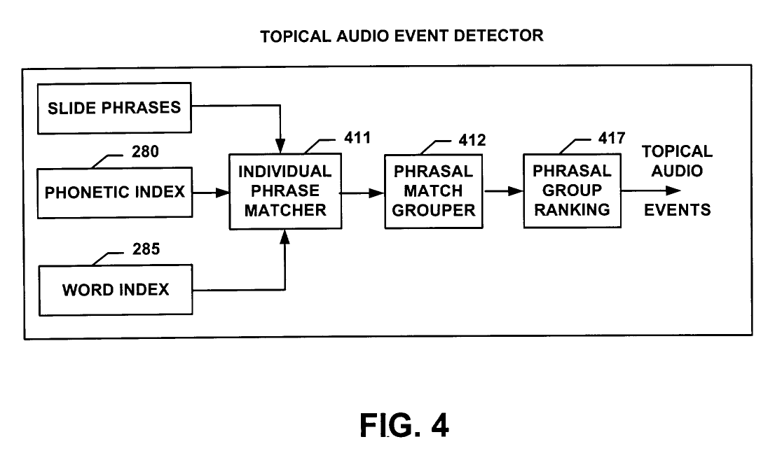

An exemplary detailed operation of the topical event detector 10 is outlined in FIG. 4. Given a query phrase sequence S{Q}=(q{1}, q{2}, . . . q{n}), an individual phrase matcher 411 retrieves matches to individual words of the sequence q{i} based on the combined word and phoneme index. Specifically, a set {t{qᵢⱼ},p{qᵢⱼ}} is constructed, where t{qᵢⱼ} represents the time of occurrence of the j^{th} match to the i^{th} query word qi based on the word index or phoneme index or both. The term p{qᵢⱼ} may be recognized as the probability of relevance of the match. The determination of p{qj} relies on a simple, linear combination of matching word and phoneme indices.

The resulting sets {t_{qi}, p_{qi}} for all query phrase words are then arranged in time-sorted order to form a long match sequence:

S_{M}=(s₁,s₂, . . . Sₘ),

where the i^{th} match sᵢ=(qⱼ, t_{qjk}=tᵢ, p_{qjk}) in the combined sequence corresponds to the k^{th} match for some query word, qᵢ. In this case, m is the total number of matches to all query words in the phrase.

The best match to the overall query phrase that preserves the order of occurrence of the words is then found by enumerating all common, contiguous subsequences W{q}=w{1}, w{2}, . . . w{i} of S_{M}, the long match sequence, and S_{Q}, the query phrase sequence. The sequence W{q} is considered a contiguous subsequence of S_{M} if there exists a strictly increasing sequence (i₁, i₂, . . . iₖ) of indices of S_{M} such that wⱼ=siⱼ for j=1,2, . . . ,k and iⱼ−iⱼ₋₁<τ. The threshold, τ, represents the average time between two words in a spoken phrase.

When words are consecutive this is typically on the order of one second for most speakers. The probabilities of relevance of each such subsequence is then computed simply as the average of the relevance score for each of its element matches. Matches to the individual words are assumed to be mutually exclusive. All those with probabilities of relevance above a chosen threshold are retained as matches to a query phrase in the individual phrase matcher 411

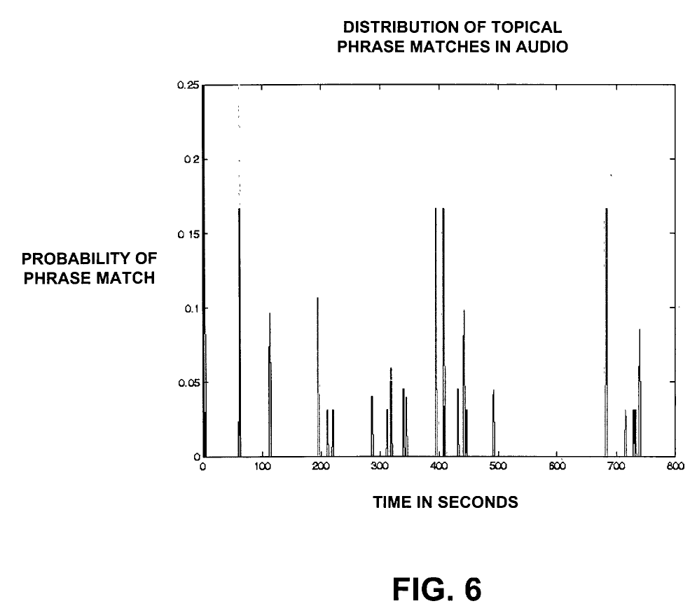

FIG. 6 shows the phrasal match distribution in the audio for a foil query with topical phrases as shown in FIG. 5. A single phrase can find match at multiple time instants in the audio information. While individual matches to phrases can be widely distributed, there are points in time where a number of these matches either co-occur or occur within a short span of time. If such matches can be grouped based on inter-phrasal match distance, then it is likely that at least one such group spans the topical audio event conveyed by the foil. This is an important observation behind combining phrasal matches to detect topical audio events in the phrasal match grouper 412.

Specifically, the phrasal match grouper 412 uses a time threshold to group phrasal matches into individual topical audio events. The pattern of separation between individual phrasal matches can be analyzed over a number of videos and foils to derive a threshold for inter-phrasal match distance. As an illustration, inter-phrasal match distributions for phrases were recorded for more than 350 slides and a collection of more than 20 videos and the inter-phrasal match distance difference was noted during the duration over which the topic conveyed by the foil was actually discussed. The resulting distribution of the difference indicates a peak in the distribution between 1 and 20 seconds, indicating that for most speakers and most topics, the predominant separation between utterances of phrases tends to be between 1 and 20 seconds apart. Thus, a 20 second time duration was chosen as the inter-phrase match distance threshold to group phrases in the phrasal match grouper 412.

The grouping process uses a connected component algorithm to merge adjacent phrasal matches that are within the inter-phrase match distance threshold of each other. The connected component algorithm uses a fast data structure called the union-find to perform the merging. During grouping, multiple occurrences of a match to a phrase are allowed within a group to handle cases when a phrase emphasizing a point of discussion was uttered frequently.

The resulting time intervals form the basic localization units of the topical event using the audio cue. However, not all such interval groups may be relevant to the topical audio event. That is, while it is common for multiple matches to occur for individual topical phrases that look equally good, a discussion containing all the topical phrases on a given foil are seldom repeated.

Time interval groups derived above are then ranked based on their relevance to the topical audio event in the phrasal group ranking module 417. The probabilities of relevance are computed from the individual phrasal match probability within the group. Let the topical audio event be denoted by Eₐ and, further, let the probability that a time interval Gⱼ=(Lⱼ(Eₐ), Hⱼ(Eₐ)) contains Eₐ be denoted by P(Gⱼ|Eₐ). (Lⱼ(Eₐ), Hⱼ(Eₐ)) are the lower and upper end points, respectively, of the time interval of the j^{th} match for the topical audio event Ea.

Let the time and probability of matches to query phrase qpᵢ be denoted as {(T_{qpij}, P_{qpij})}. Since the individual phrase matches with Gⱼ occupy distinct time intervals, the mutual exclusiveness assumption holds, so that P can be assembled as:

P(Gⱼ|Eₐ)=ΣP_{pqrs}/(Σ all i Σ all j P_{pqiJ}),

where the intervals T_{pqrs}εG_{J}.

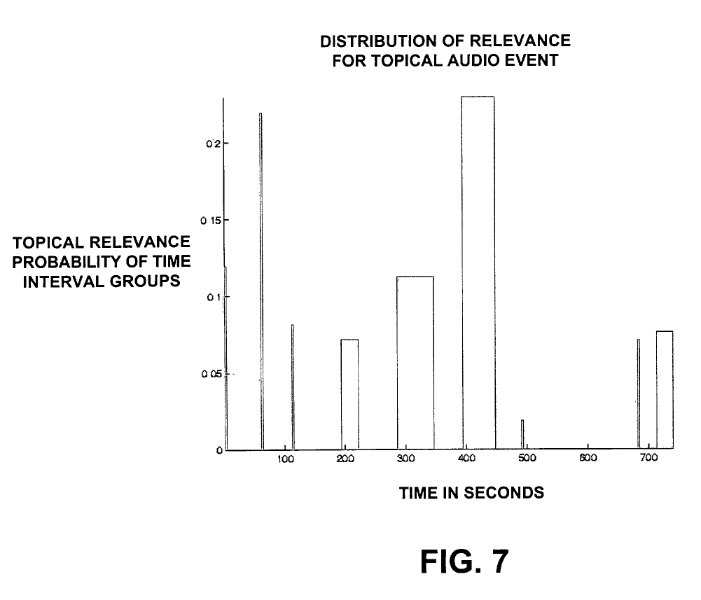

The resulting ranked phrasal groups are shown in FIG. 7 for the phrasal match distribution of FIG. 6.

In the above description the audio cue alone was used to determine topical revelance. By using visual processing and noticing the combining the audio and video matches using their time co-occurrence, an even stronger clue to the correctness of the detected location for the topic can be obtained.

Combination methods for multi-modal fusion such as “AND” or “OR” of the intervals do not yield satisfactory solutions. That is, a simple AND of the durations can result in too small a duration to be detected for the overall topic, while an “OR” of the results can potentially span the entire video segment, particularly, when the audio and video matches are spread over the length of the video. Other combination methods such as winner-take-all used in past approaches are also not appropriate here since the probabilities of relevance of durations for events given by neither the audio nor the video matches are particularly salient for clear selection. In addition, weighted linear combination methods are also not appropriate as they do not exploit time co-occurrence.

The approach to multi-modal fusion is based on the following guiding rationale: (a) the combination method should exploit the time co-occurrence of individual cue-based event detections; (b) the selected duration for the overall topical event must show graceful begin and end to match the natural perception of such events; (c) the combination should exploit the underlying probabilities of relevance of a duration to event given by individual modal matches.

It is to be understood that the specific embodiments of the present invention that are described herein are merely illustrative of certain applications of the principles of the present invention. Numerous modifications may be made without departing from the scope of the invention.

What is claimed is:

1. A method for automatically detecting and retrieving topical events from a recording that comprises digital audio signals, comprising:
searching for a length in the recording during which a desired topic of discussion is heard, wherein the desired topic of discussion is identified and summarized by a group of text phrases on a slide;
detecting a query-driven topical event using time-localized textual phrases on foils as an indication of a topic; and
wherein detecting the query-driven topical event further comprises detecting topical audio events using a text content of the slide as the indication of the topic.

2. The method of claim 1, wherein searching comprises using a combination of word and phonetic recognition of the audio signals.

3. The method of claim 2, wherein searching further comprises using an order of occurrence of words in a phrase to one or more return points.

4. The method of claim 3, further comprising combining individual phrase matches into a topical match.

5. The method of claim 4, wherein combining individual phrase, matches into the topical match comprises using a probabilistic combination model that exploits a contiguity of occurrence of the individual phrase matches.

6. The method of claim 5, wherein detecting comprises observing patterns of co-occurrence of individual topical phrasal matches in the audio signals.

7. The method of claim 6, further including extracting audio track information from the audio signals; and using a speech recognition engine to generate a word transcript.

8. The method of claim 7, further including imposing a sentence structure using a language model through tokenization, followed by stop-word removal to prevent excessive false positives during retrieval.

9. The method of claim 8, further including accounting for errors in word boundary detection, word recognition and out-of-vocabulary words, by building a time-based phonetic index.

10. The method of claim 9, further including admitting text phrases arising from a non-audio data source.

11. The method of claim 10, wherein admitting text phrases comprises admitting text phrases from a text script.

12. The method of claim 11, wherein admitting text phrases comprises admitting text phrases from a hardcopy foil.

13. A computer program product having instruction codes for automatically detecting and retrieving topical events from a recording that comprises digital audio signals, comprising:
a first set of instruction codes for searching for a length in the recording during which a desired topic of discussion is heard, wherein the desired topic of discussion is identified and summarized by a group of text phrases on a slide;
a second set of instruction codes for detecting a query-driven topical event using time-localized textual phrases on foils as an indication of a topic; and
a third set of instruction codes for detecting topical audio events using a text content of the slide as the indication of the topic.

14. The computer program product of claim 13, wherein the first set of instruction codes uses a combination of word and phonetic recognition of the audio signals.

15. The computer program product of claim 14, wherein the first set of instruction codes further uses an order of occurrence of words in a phrase to one or more return points.

16. The computer program product of claim 15, further comprising a fourth set of instruction codes for combining individual phrase matches into a topical match.

17. The computer program product of claim 16, wherein the fourth set of instruction codes uses a probabilistic combination model that exploits a contiguity of occurrence of the individual phrase matches.

18. The computer program product of claim 17, wherein the second set of instruction codes observes patterns of co-occurrence of individual topical phrasal matches in the audio signals.

19. The computer program product of claim 18, further comprising a fifth set of instruction codes for extracting audio track information from the audio signals, and for using a speech recognition engine to generate a word transcript.

20. The computer program product of claim 19, further comprising a six set of instruction codes for imposing a sentence structure that uses a language model through tokenization, followed by stop-word removal to prevent excessive false positives during retrieval.

21. The computer program product of claim 20, further comprising a seventh set of instruction codes for accounting for errors in word boundary detection, word recognition and out-of-vocabulary words, by building a time-based phonetic index.

22. The computer program product of claim 21, further comprising an eight set of instruction codes for admitting text phrases arising from a non-audio data source.

23. The computer program product of claim 22, wherein the eight set of instruction codes further admits text phrases from a text script.

24. The computer program product of claim 23, wherein the eight set of instruction codes admits text phrases from a hardcopy foil.

25. A system for automatically detecting and retrieving topical events from a recording that comprises digital audio signals, comprising:
means for searching for a length in the recording during which a desired topic of discussion is heard, wherein the desired topic of discussion is identified and summarized by a group of text phrases on a slide;
means for detecting a query-driven topical event using time-localized textual phrases on foils as an indication of a topic; and
means for detecting topical audio events using a text content of the slide as the indication of the topic.

26. The system of claim 25, wherein the means for searching uses a combination of word and phonetic recognition of the audio signals.

27. The system of claim 26, wherein the means for searching uses an order of occurrence of words in a phrase to one or more return points.

28. The system of claim 27, further comprising means for combining individual phrase matches into a topical match.

29. The system of claim 28, wherein the means for combining individual phrase matches uses a probabilistic combination model that exploits a contiguity of occurrence of the individual phrase matches.

30. The system of claim 29, wherein the means for detecting the query-driven topical event observes patterns of co-occurrence of individual topical phrasal matches in the audio signals.

31. The system of claim 30, further comprising means for extracting audio track information from the audio signals, and for using a speech recognition engine to generate a word transcript.

32. The system of claim 31, further comprising means for imposing a sentence structure that uses a language model through tokenization, followed by stop-word removal to prevent excessive false positives during retrieval.

33. The system of claim 32, further comprising means for accounting for errors in word boundary detection, word recognition and out-of-vocabulary words, by building a time-based phonetic index.

34. The system of claim 33, further comprising means for admitting text phrases arising from a non-audio data source.

35. The system of claim 34, wherein the means for admitting text phrases further admits text phrases from a text script.

36. The system of claim 35, wherein the means for admitting text phrases admits text phrases from a hardcopy foil.

37. A system for automatically detecting and retrieving topical events from a recording that includes digital audio signals, comprising:
a search engine that searches for a length in the recording during which a desired topic of discussion is heard, wherein the desired topic of discussion is identified and summarized by a group of text phrases on a slide;
a detector that detects a query-driven topical event in the length, using time-localized textual phrases on foils as an indication of a topic; and
a topical audio event detector that uses a text content of slides as indications of the topic.

38. The system of claim 37, wherein the search engine includes a word and phonetic recognition module that processes the audio signals to generate word and phonetic indices.

39. The system of claim 38, wherein the search engine uses an order of occurrence of words in a phrase to one or more return points.

40. The system of claim 39, further including an audio event detection module that combines individual phrase matches into a topical match.

41. The system of claim 40, wherein the audio event detection module combines individual phrase matches into the topical match includes using a probabilistic combination model that exploits a contiguity of occurrence of the individual phrase matches.

42. The system of claim 41, wherein the event detector that detects the query-driven topical event observes patterns of co-occurrence of individual topical phrasal matches in the audio signals.
